(19) United States
(12) Patent Application Publication
(10) Pub. No.: US 2025/0200491 A1
(43) Pub. Date: Jun. 19, 2025

(54) SYSTEM AND METHOD FOR GENERATING TRAINING RECOMMENDATIONS VIA AUTOMATED INTERACTION EVALUATION

(71) Applicant: NICE LTD., Ra'anana (IL)

(72) Inventors: Amol ANWADE, Pune (IN); Lilach Zemach, Dunwoody, GA (US); Sourav Rath, Pune (IN); Shay Diner, Holon (IL)

(73) Assignee: NICE LTD., Ra'anana (IL)

(21) Appl. No.: 18/540,387

(22) Filed: Dec. 14, 2023

(51) Int. Cl. G06Q 10/0639; G06N 3/0455

(52) U.S. Cl. CPC G06Q 10/06398; G06N 3/0455

(57) ABSTRACT

A system for evaluating agent performance in interactions and generating training recommendations for agents based on the evaluated agent performance may include a computing device; a memory; and a processor, the processor configured to: create a plurality of evaluation prompts for evaluating interaction data items of one or more interactions; generate evaluation results for the interaction data items using the plurality of evaluation prompts and machine learning; create training recommendation prompts for the evaluation results; and generate training recommendations from training categories using the training recommendation prompts and machine learning.

### TECHNICAL FIELD OF THE INVENTION

The present invention relates generally to the automatic assessment of agent performance in contact centers, and the generation of training recommendations which are based on the assessment.

### BACKGROUND OF THE INVENTION

Current technology used for evaluating and training agents, e.g. the evaluation of random samples of individual customer reviews, have been found to be ineffective, as they may not be representative for all interactions of an agent and may lead to problems in the identification of personal training recommendations. For example, a small sample of evaluated interactions of a large number of interactions that are evaluated may be in conflict with a coach's requirement to evaluate as much data as possible to provide individual and comprehensive training recommendations for an agent.

In addition, scalability can be a major concern in contact centers that have hundreds or thousands of agents handling a large number of interactions with a limited quality assurance team. Thus, one of the challenges in the evaluation of agents in contact centers may be the selection of relevant interactions to limit the number of reviewed interactions for a quality team that cannot evaluate all of the recorded interactions.

Another challenge in this field may be the provision of consistent and objective evaluation of agent interactions and limiting biases in evaluations across different agents and between different evaluators. This can be difficult to achieve, especially when aiming to provide personalized training recommendations that are targeted to individual agents.

Thus, there is a need for the automatic evaluation of agent performance and the automatic generation of training recommendations based on recorded agent performance. Thereby, automated quality management (QM) evaluators may be required to possess the ability to identify and evaluate complex interactions. This may help to provide accurate assessments and suitable training recommendations that help agents improve their performance.

### SUMMARY OF THE INVENTION

Improvements and advantages to interaction handling technology may include evaluating agent performance based on all/a majority of all recorded agent interactions, and thus, providing a holistic evaluation of all interaction recorded for an agent.

Improvements and advantages may further include the automatic assessment of agents based on objective and unbiased evaluation criteria allowing to provide training recommendations that take into account a high proportion of the interactions recorded for an agent thereby creating an individual assessment of the performance for each agent of a contact center.

In addition, improvements and advantages to text and interaction processing technology may include the use of generative artificial intelligence in the automatic evaluation and generation of training recommendations that may allow automatically detecting patterns, and offering personalized training recommendations.

Embodiments may include a method of evaluating agent performance in interactions and generating training recommendations for agents based on the evaluated agent performance, the method including: creating a plurality of evaluation prompts for evaluating interaction data items of one or more interactions; generating evaluation results for the interaction data items using the plurality of evaluation prompts and machine learning; creating training recommendation prompts for the evaluation results and generating training recommendations from training categories using the training recommendation prompts and machine learning.

In one embodiment, a system for evaluating agent performance in interactions and generating training recommendations for agents based on the evaluated agent performance may include: a computing device, a memory, and a processor, the processor configured to: create a plurality of evaluation prompts for evaluating interaction data items of one or more interactions; generate evaluation results for the interaction data items using the plurality of evaluation prompts and machine learning; create training recommendation prompts for the evaluation results; and generate training recommendations from training categories using the training recommendation prompts and machine learning.

In one embodiment, generating evaluation results includes comparing one or more performance indicators identified in the interaction data items with pre-set threshold values for the performance indicators.

In one embodiment, the training recommendation prompts are created for the evaluation results that include one or more performance indicators that are lower than set thresholds for the one or more performance indicators.

In one embodiment, creating evaluation prompts includes creating a vector store for the interaction data items from chunks of the interaction data items.

In one embodiment, generating evaluation results for the evaluation prompts includes conducting a similarity search using the vector store.

In one embodiment, the training categories are separated into training data items that are stored in a vector store.

In one embodiment, generating training recommendations includes conducting a similarity search using the training data items vector store.

In one embodiment, the machine learning includes generative artificial intelligence.

In one embodiment, the evaluation prompts and training recommendation prompts are submitted to a large language machine learning model.

In one embodiment, the training recommendations are based on previously generated evaluation results for the agent.

In one embodiment, each evaluation prompt of the plurality of evaluation prompts includes interaction data items which are present in previously or subsequently created evaluation prompts.

Embodiments may include a method of rating agent performance in interactions and providing suggestions for improvement, the method including: creating one or more prompts for the evaluation of interaction data items in one or more interactions; generating performance results for the interaction data items using the one or more prompts for the evaluation of interaction data items and machine learning; creating coaching recommendation prompts for the performance results; and generating coaching recommendations from coaching categories using the coaching recommendation prompts and machine learning.

In one embodiment, the quality management system includes one or more of: an evaluation software, a calibration software and a quality planner software.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a high-level block diagram disclosing available evaluation flows for the assessment of agents, according to the prior art.

FIG. 2 shows a high-level block diagram disclosing available training recommendation flows, according to the prior art.

FIG. 3 is a high-level block diagram of an exemplary system, according to embodiments of the present invention.

FIG. 4 is a schematic drawing of a system for evaluating agent performance in interactions and generating training recommendations for agents based on the evaluated agent performance, according to some embodiments of the invention.

FIG. 5 is a flowchart of evaluating agent performance in interactions and generating training recommendations for agents based on the evaluated agent performance, according to embodiments of the present invention.

FIG. 6 is a high-level block diagram of an exemplary system for a periodic evaluation and identification of training opportunities, according to embodiments of the present invention.

FIG. 7 is a high-level block diagram of an exemplary system for a periodic evaluation and identification of training opportunities, according to embodiments of the present invention.

FIG. 8 is a high-level block diagram of an exemplary system providing an overview of the data flow in a periodic evaluation and identification of training opportunities, according to embodiments of the present invention.

FIG. 9 is a high-level block diagram of an exemplary system for the auto-evaluation of interactions and the generation of training recommendations, according to embodiments of the present invention.

FIG. 10 is a high-level block diagram of an exemplary method for the identification of training categories, according to embodiments of the present invention.

FIG. 11 is a high-level block diagram of an exemplary method for the creation of training recommendations from evaluation results, according to embodiments of the present invention.

FIG. 12 depicts an example of a quality management (QM) evaluation form, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “contact center” may refer to a centralized office used for receiving or transmitting a large volume of enquiries, communications, or interactions. The enquiries, communications, or interactions may utilize telephone calls, emails, message chats, SMS (short message service) messages, etc. A contact center may, for example, be operated by a company to administer incoming product or service support or information enquiries from customers/consumers. The company may be a contact-center-as-a-service (CCaaS) company.

As used herein, “call center” may refer to a contact center that primarily handles telephone calls rather than other types of enquiries, communications, or interactions. Any reference to a contact center herein should be taken to be applicable to a call center, and vice versa.

As used herein, “interaction” may refer to a communication between two or more people (e.g., in the context of a contact center, an agent and a customer), typically via devices such as computers, customer devices, agent devices, etc., and may include, for example, voice telephone calls, conference calls, video recordings, face-to-face interactions (e.g., as recorded by a microphone or video camera), emails, web chats, SMS messages, etc. An interaction may be recorded to generate an “interaction recording”. An interaction, or interaction recording, may also refer to data which is transferred and stored in a computer system recording the interaction and may represent an interaction, including for example voice or video recordings, data items describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), emails, web chats, SMS messages, etc. Interactions may be computer-based if, for example, the interaction has associated data or metadata items stored or processed on a computer, the interaction is tracked or facilitated by a server, the interaction is recorded on a computer, data is extracted from the interaction, etc. Some computer-based interactions may take place via the internet, such as some emails and web chats, whereas some computer-based interactions may take place via other networks, such as some telephone calls and SMS messages. An interaction may take place using text data, e.g., email, web chat, SMS, etc., or an interaction may not be text-based, e.g., voice telephone calls. Non-text-based interactions may be converted into text-based interaction recordings (e.g., using automatic speech recognition). Interaction data and Interaction recordings may be produced, transferred, received, etc., asynchronously.

As used herein, “agent” may refer to a contact center employee that answers incoming interactions, and may, for example, handle customer requests.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input sample data may include a transcript of an interaction and a label indicating whether or not the interaction was satisfactory. In an unsupervised ML approach, the input sample data may not include any labels, for example, in the present application, the input sample data may include interaction transcripts only.

ML models may, for example, include (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g., artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

An “evaluation of agent performance” or a “quality evaluation” may be a quality management activity in which another individual, e.g. a supervisor or an evaluator of a quality management (QM) team may generate a rating for an agent-client interaction of an agent, e.g. an agent using computing device 300 or 410, based on key criteria that are set in a quality form. Quality evaluations may provide feedback for agents on their performance and may act as a foundation for training/coaching and improvement of agent-client interaction.

Quality evaluations may be part of QM, where a supervisor, e.g. a coach 702 of an agent, evaluates an agent's performance based on a quality/evaluation form. These assessments may provide an agent with feedback and may provide a foundation for coaching and improvement.

Commonly, evaluations of agents may be executed by an evaluation team of a contact center, or individual supervisors and managers. Accordingly, an efficient quality management software may be crucial and desired for a smooth execution of the evaluation.

Incorporating self-assessments into the quality management program may also be beneficial, since agents can evaluate their own interactions, prepare for their 1:1 meetings with their supervisors and improve their performance during agent-customer interactions. After completion of an evaluation, agents may review the evaluation and feedback. A quality management software may help to automate such an evaluation process.

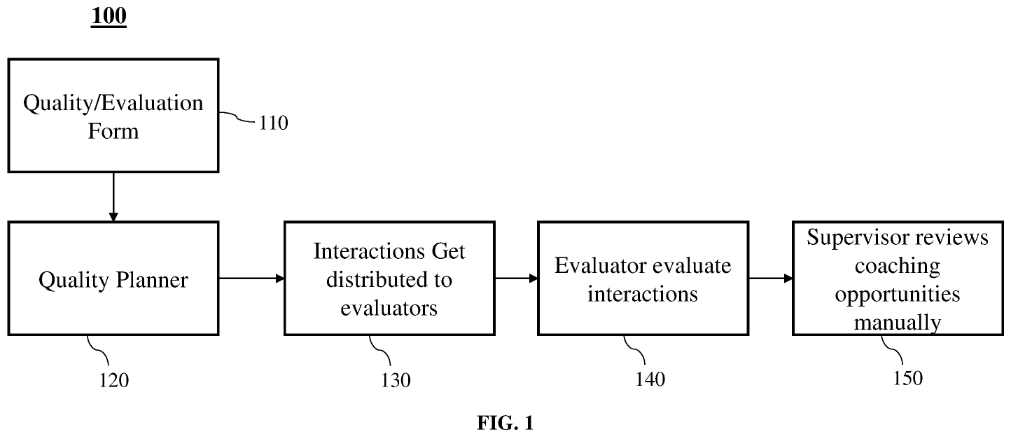

In FIG. 1, an exemplary flow of known interaction evaluation processes of contact centers is shown. In a current evaluation process known in the prior art, a quality administrator, e.g. a supervisor or manager of agents of a contact center, may create a quality evaluation form 110 according to relevant criteria, to evaluate agents of a contact center. Using a quality planner, e.g. quality planner 120, interactions may be distributed between evaluators or supervisors (130). Evaluators may run evaluations of agent interactions, e.g. agent interactions stored on agent device 410 or computing device 402. Subsequent matching of interactions to criteria set in a quality plan may allow evaluators/supervisors to assess the performance of an agent in previous interactions (140). For example, evaluators may assess the interactions by interacting with agents, e.g. listening or reading to them, based on a quality/evaluation form. After an evaluation, a supervisor may review the evaluation form and may calculate agent scores and evaluator suggestions for an agent (150) to identify areas for improvement and training recommendations for agents.

Due to the time-consuming evaluation processes, traditional agent evaluation methods may struggle to identify specific coaching opportunities and cannot provide tailored recommendations of manual agent assessments that can only reflect a small number of evaluations compared to the entire number of available interactions that could be used in the assessment of agents. As a result, evaluations of an agent using a small number of interaction samples for a particular agent may not include the most impactful coaching opportunities and, thus, may generate an inaccurate evaluation of an agent that is based on a limit number of evaluated interactions.

Scalability of evaluations may be a concern in large contact centers, and ensuring consistency, objectivity, and addressing biases in evaluations may be challenging both for the same evaluator scoring multiple agents or multiple evaluators that have different style of scoring. Quality management evaluators may be required to understand and evaluate complex interactions for accurate assessments and effective coaching. These issues can lead to inaccurate identification of coaching opportunities.

In order to improve agent performance, contact centers may devise educational methodologies for personnel, configured to be consistent with their authentic needs. This can be accomplished through an integrative approach that amalgamates insights obtained from various applications, in conjunction with industry exemplary practices, assessment determinations, and pertinent subject matter relating to the propagation of knowledge.

A “coach” or a “trainer” may be a supervisor who is in charge of initiating and carrying out “training sessions” or “coaching sessions”, may take into account various aspects such as the agent's performance, strengths and weaknesses, productivity, and skill level to identify agents in need of guidance. For example, evaluation of interaction data items of interactions may allow a coach or trainer to assess the performance of an agent during an interaction. Interaction data items may be parameters that can be extracted from an interaction. For example, interaction data items may be obtained from the content of interactions between an agent and a customer, e.g. the detection of words such as “hello”, “good bye” or “good morning” in a transcript may allow determining whether an agent has used a greeting when engaging with a customer. Interaction data items may also be derivable from analytical data, e.g. the duration of a call or whether a call was elevated from a first agent to a second agent to solve a problem, e.g. in case that the first agent lacked knowledge to provide a customer with a full response to a question.

Coaching or training sessions may of agents may be carried out periodically, e.g. one every week, month or year. They can also be scheduled non-periodically, e.g. once a particular issue in the handling of interactions of an agent was identified. In a coach session, a trainer or coach such as a supervisor of an agent may provide an agent with feedback on the handling of interactions. An agent may then apply knowledge gained during the coaching session to improve their overall performance, using the discussed topics, insights, and any assigned tasks to strengthen their learning experience.

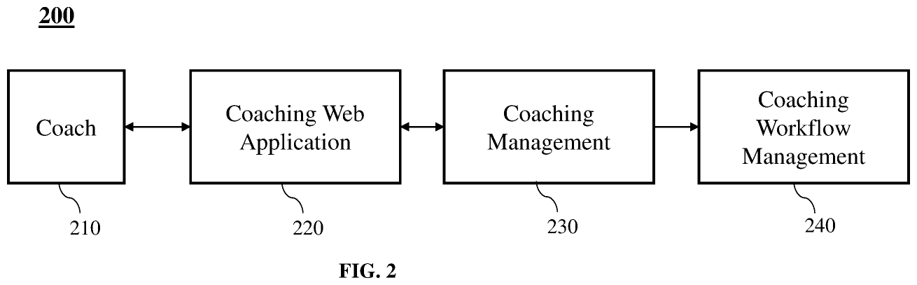

In FIG. 2, a high-level block diagram disclosing available training recommendation flows, e.g. flow 200, is depicted. In prior art systems, coaching sessions for agents may be designed and prepared by a coach. These sessions are formulated considering the agents' performance indicators, their strong and weak points, productivity levels, and interaction evaluations.

To establish a coaching session, a coach 210 may access a coaching platform, e.g. coaching web application 220, and may organize sessions for individual or multiple agents. A coaching platform application 230 may be tasked with producing coaching sessions, collaborates with other services to ensure the thorough execution of session formation. This service may obtain information from the web application, as mentioned earlier, and set up a coaching session within the system. Throughout this procedure, a coach may generate evaluation results, e.g. for focus areas and an associated behaviors, and may review previous interactions of an agent. Furthermore, the coach has the option to include knowledge-based resources in the session for the agents to consult.

Focus areas may be parameters that can be calculated from interaction data items and may indicate the performance of an agent in an interaction. For example, “average handling time” (AHT) may be a key performance indicator (KPI) that measures the average amount of time an agent spends handling a customer interaction, including talk time, hold time, and after-call work. In the calculation of an AHT value, behaviors of an agent during an interaction such as:
Active listening: Paying close attention to customer's concerns and gathering information to address their needs quickly and accurately.
Effective questioning: Asking relevant and targeted questions to collect necessary information from customers, which helps in understanding their issues and finding solutions efficiently.
Clear and concise communication: Using simple, straightforward language to explain solutions or provide instructions, which can help reduce the time spent on each interaction.
Time management: Prioritizing tasks during and after the call, allocating appropriate time for each activity, and focusing on the most critical aspects of the interaction.
Call control: Maintaining control of the conversation, guiding customers through the interaction, and avoiding unnecessary digressions or distractions.
Quick problem-solving: Applying critical thinking and technical skills to diagnose issues and determine the most efficient solutions.
Knowledge of resources: Being familiar with internal resources, tools, and systems, which enables agents to access information quickly and reduce hold times.
Escalation awareness: Knowing when to escalate a call to a higher level of support to resolve complex issues efficiently.
Efficient after-call work: Completing post-call tasks, such as updating customer records and documenting call outcomes, promptly and accurately.
   may be considered in the calculation.

In another example, a focus area may be “Customer Satisfaction” (CSAT). CSAT may be a KPI that measures the level of satisfaction customers have with the service they receive during interactions with contact center agents. It can be a metric for contact centers because it directly reflects the quality of customer experience and helps identify areas for improvement. In the calculation of CSAT, behaviors of an agent during an interaction such as:
Active listening: The practice of fully concentrating on what the customer is saying, understanding their message, and responding thoughtfully. This helps customers feel heard and understood, which contributes to their satisfaction.
Empathy: The ability to put oneself in the customer's shoes and understand their emotions, concerns, and needs. Empathy helps agents connect with customers on a personal level and provide more compassionate service.
Effective communication: The skill of conveying information clearly, concisely, and professionally, using language that is easy for customers to understand. This ensures that customers receive accurate and helpful information, promoting a positive experience.
Product knowledge: Comprehensive understanding of the products or services being supported, enabling agents to provide accurate and helpful information to customers. This ensures that customers receive the assistance they need, leading to higher satisfaction.
Problem-solving skills: The ability to analyze customer issues, think critically, and offer appropriate solutions in a timely manner. Effective problem-solving helps resolve customer concerns quickly and efficiently, contributing to a positive experience.
Personalization: The practice of using customer information to tailor interactions and make customers feel recognized and valued. This can include using the customer's name, referencing past interactions, or acknowledging customer preferences.
Emotional intelligence: The capacity to recognize, understand, and manage one's own emotions and the emotions of others. Agents with high emotional intelligence can navigate difficult situations with customers more effectively, leading to improved satisfaction.
Timeliness and responsiveness: The ability to respond promptly to customer inquiries and follow up on any commitments made during the interaction. This demonstrates respect for the customer's time and contributes to a positive experience.
Adherence to procedures and policies: Following company guidelines and regulatory requirements while maintaining a high level of customer service. This ensures consistent, compliant, and reliable service for customers.
   may be considered in the calculation.

In another example, a focus area may be “First Call Resolution” (FCR). FCR may be a KPI that measures the percentage of customer issues resolved during a first interaction with a contact center agent. It is an important metric because it directly impacts customer satisfaction, operational efficiency, and overall contact center performance. In the calculation of CSAT, behaviors of an agent during an interaction such as:
Active listening: The practice of fully concentrating on what the customer is saying, understanding their message, and responding thoughtfully. Active listening helps agents to better understand the customer's issue, increasing the likelihood of resolving it during the first interaction.
Effective questioning: The skill of asking relevant and targeted questions to collect necessary information from customers. This enables agents to understand the issue more clearly and find appropriate solutions, increasing the chances of FCR.
Problem-solving skills: The ability to analyze customer issues, think critically, and offer appropriate solutions in a timely manner. Effective problem-solving helps resolve customer concerns quickly and efficiently, contributing to a higher FCR rate.
Product knowledge: Comprehensive understanding of the products or services being supported, enabling agents to provide accurate and helpful information to customers. This helps agents to address customer issues effectively during the first interaction, increasing FCR.
Call control: The skill of maintaining control of the conversation, guiding customers through the interaction, and avoiding unnecessary digressions or distractions. Call control enables agents to focus on resolving the issue at hand, improving the chances of FCR.
Efficient use of resources and tools: Proficiency in using internal systems, knowledge bases, and other resources to quickly access information and resolve customer issues. This helps agents to find solutions more efficiently, contributing to a higher FCR rate.
Escalation awareness: Knowing when to escalate a call to a higher level of support or involve other departments to resolve complex issues effectively. This ensures that customers receive the appropriate assistance, increasing the likelihood of resolving their issue during the first interaction.
Clear and concise communication: The skill of conveying information clearly, concisely, and professionally, using language that is easy for customers to understand. This ensures that customers receive accurate and helpful information, promoting a positive experience and increasing the chances of FCR.
   may be considered in the calculation.

The process of determining focus areas, behaviors, interactions, and document attachments may in prior art systems be carried out by the coach manually, without any guidance to evaluate their pertinence. As a result, the process depends on the coach's abilities, awareness, and discretion, making it subjective in nature.

The workflow service, e.g. coaching workflow management 240, may assist in the creation and management of workflows for each training session. These workflows are technically implemented using any workflow service.

Presently available coaching systems mainly emphasize the observation of agent performance metrics and their manual correlation with coaching materials, such as focus areas and behavior to be coached to. This approach often depends on the coach's skills, visibility, and judgment, making it subjective and prone to inconsistencies. As a result, multiple coaches may draw entirely different conclusions from the same data.

Prior art processes may enhance agent performance (e.g. indirectly improving customer experience) by relying on manual procedures and human judgment based on limited data, rather than focusing on a broader set of past interactions, and evaluations. This reliance on manual processes for interaction evaluation and coaching opportunity identification increases the likelihood of errors.

Moreover, the absence of insights into coaching opportunity identification and targeted content negatively affects coaching effectiveness, ultimately undermining the efficient use of time for both the coach and the agent.

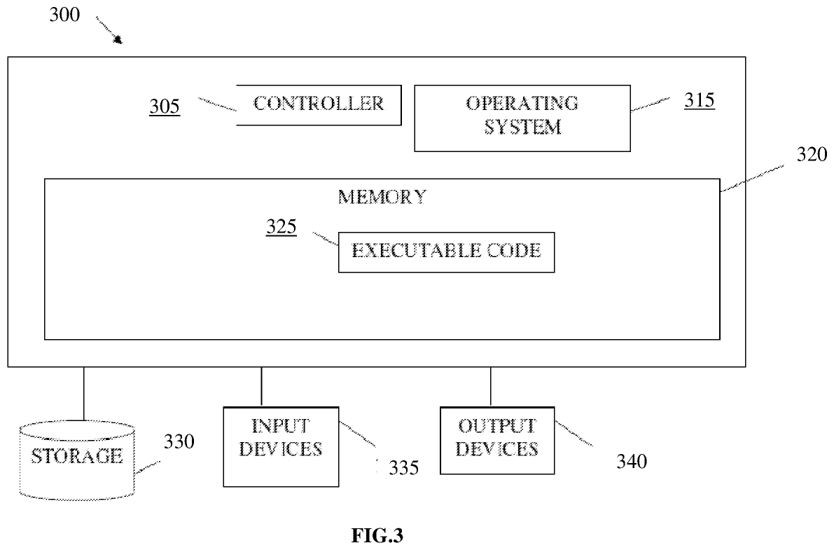

FIG. 3 shows a high-level block diagram of an exemplary computing device which may be used with embodiments of the present invention. Computing device 300 may include a controller or processor 305 that may be, for example, a central processing unit processor (CPU), a chip or any suitable computing or computational device, an operating system 315, a memory 320, a storage 330, input devices 335 and output devices 340 such as a computer display or monitor displaying for example a computer desktop system. Each of modules and equipment and other devices and modules discussed herein, e.g. computing device 402, agent device 510, customer device 520, and modules, for example an interaction analytics module 712, a coaching service 714, or a quality management module 716 and modules in FIGS. 3, 4, 5, 6, 7, 8, 9, 10, 11, 12 may be or include, or may be executed by, a computing device such as included in FIG. 3 although various units among these modules may be combined into one computing device.

Operating system 315 may be or may include any code segment designed and/or configured to perform tasks involving coordination, scheduling, arbitration, supervising, controlling or otherwise managing operation of computing device 300, for example, scheduling execution of programs. Memory 320 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 320 may be or may include a plurality of, possibly different memory units. Memory 320 may store for example, instructions (e.g. code 325) to carry out a method as disclosed herein, and/or data.

Executable code 325 may be any executable code, e.g., an application, a program, a process, task or script. Executable code 325 may be executed by controller 305 possibly under control of operating system 315. For example, executable code 325 may be one or more applications performing methods as disclosed herein, for example those of FIG. 3 according to embodiments of the present invention. In some embodiments, more than one computing device 300 or components of device 300 may be used for multiple functions described herein. For the various modules and functions described herein, one or more computing devices 300 or components of computing device 100 may be used. Devices that include components similar or different to those included in computing device 300 may be used, and may be connected to a network and used as a system. One or more processor(s) 305 may be configured to carry out embodiments of the present invention by, for example, executing software or code. Storage 330 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 330 and may be loaded from storage 330 into a memory 320 where it may be processed by controller 305. In some embodiments, some of the components shown in FIG. 3 may be omitted.

Input devices 335 may be or may include a mouse, a keyboard, a touch screen or pad or any suitable input device. It will be recognized that any suitable number of input devices may be operatively connected to computing device 300 as shown by block 335. Output devices 340 may include one or more displays, speakers and/or any other suitable output devices. It will be recognized that any suitable number of output devices may be operatively connected to computing device 300 as shown by block 340. Any applicable input/output (I/O) devices may be connected to computing device 300, for example, a wired or wireless network interface card (NIC), a modem, printer or facsimile machine, a universal serial bus (USB) device or external hard drive may be included in input devices 335 and/or output devices 340.

Embodiments of the invention may include one or more article(s) (e.g. memory 320 or storage 330) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

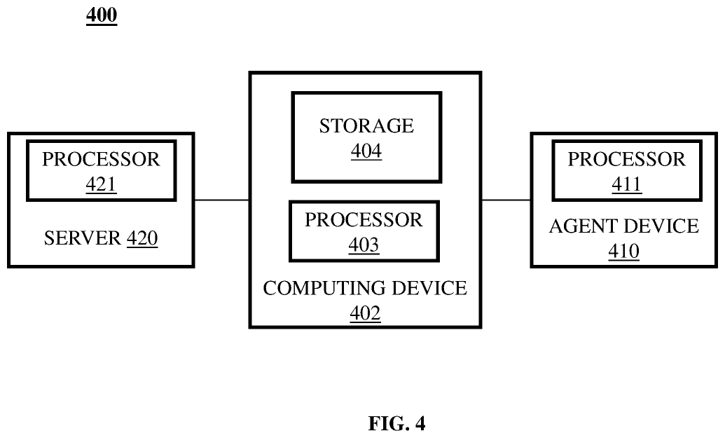

FIG. 4 is a schematic drawing of a system 400 according to some embodiments of the invention. System 400 may include a computing device 402 including a processor 403 and storage 404. Computing agent device 402 may be connected to an agent device 210 that includes processor 411. Computing device 402 may be connected to a server 420 including processor 421. Server 420 and Agent device 410 may provide computing device 402 with interaction recordings, e.g. chat transcripts, and evaluation forms, e.g. for the evaluation of agent performance. Alternatively, interaction recordings and evaluation forms may be stored in storage 404 of computing device 402.

Computing devices 300, 402, 410 and 420 may be servers, personal computers, desktop computers, mobile computers, laptop computers, and notebook computers or any other suitable device such as a cellular telephone, personal digital assistant (PDA), video game console, etc., and may include wired or wireless connections or modems. Computing devices 300, 402, 410 and 420 may include one or more input devices, for receiving input from a user (e.g., via a pointing device, click-wheel or mouse, keys, touch screen, recorder/microphone, or other input components). Computers 300, 402, 410 and 420 may include one or more output devices (e.g., a monitor, screen, or speaker) for displaying or conveying data to a user.

Any computing devices of FIGS. 3 and 4 (e.g., 300, 402, 410 and 420), or their constituent parts, may be configured to carry out any of the methods of the present invention. Any computing devices of FIGS. 3 and 4, or their constituent parts, may include an auto-evaluation and coaching opportunity finder engine 730, or another engine or module, which may be configured to perform some or all of the methods of the present invention. Systems and methods of the present invention may be incorporated into or form part of a larger platform or a system/ecosystem, such as agent management platforms. The platform, system, or ecosystem may be run using the computing devices of FIGS. 3 and 4, or their constituent parts. For example, a processor such as processor 403 of computing device 402 processor 411 of device 410, and/or processor 421 of computing device 420 may be configured to create a plurality of evaluation prompts for evaluating interaction data items of one or more interactions. For example, a processor such as processor 403, 411 and/or 421 may be configured to create a plurality of evaluation prompts using machine learning, e.g. generative artificial intelligence (Gen AI) and a large language model. A processor such as processor 403 of computing device 402 processor 411 of device 410, and/or processor 421 of computing device 420 may be configured to generate evaluation results for the interaction data items using the plurality of evaluation prompts and machine learning. A processor such as processor 403 of computing device 402 processor 411 of device 410, and/or processor 421 of computing device 420 may be configured to create training recommendation prompts for the evaluation results. For example, a processor such as processor 403, 411 and/or 421 may be configured to create a plurality of training recommendation prompts using machine learning, e.g. a Gen AI and a large language model. A processor such as processor 403 of computing device 402 processor 411 of device 410, and/or processor 421 of computing device 420 may be configured generate training recommendations from training categories using the training recommendation prompts and machine learning.

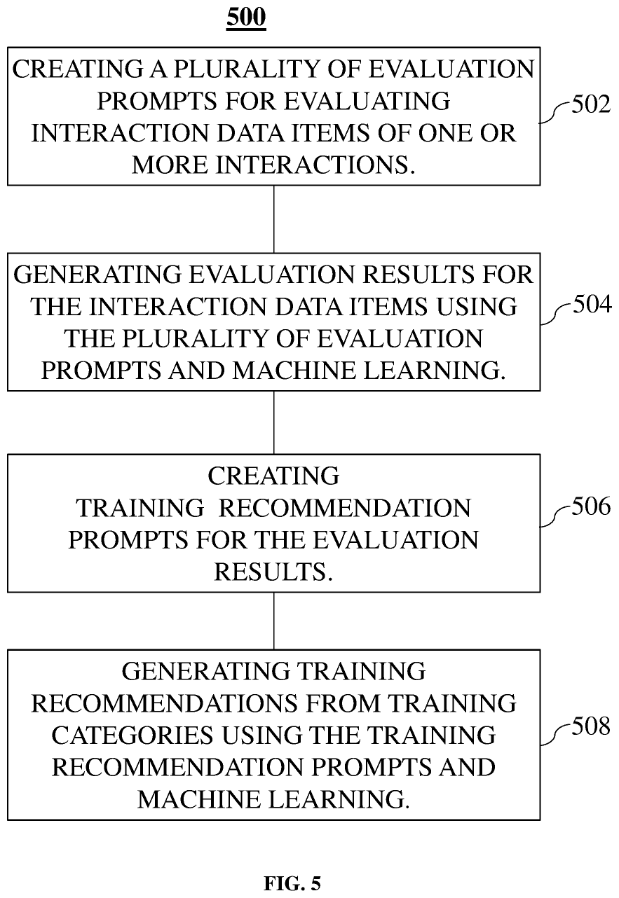

FIG. 5 shows a flowchart of a method 500 for evaluating agent performance in interactions and generating training recommendations for agents based on the evaluated agent performance that may be executed by a computing device, e.g. computing device 300 or computing device 402. The system displayed in FIG. 4 and the method shown in FIG. 5 may refer to evaluating agent performance in interactions and generating training recommendations that are retrieved from the storage of an agent device, e.g. agent device 410, or a database, e.g. server 420, however, the system and the method may also be used to evaluating agent performance in interactions and generating training recommendations for agents when executed on a server or agent device. According to some embodiments, some or all of the steps of the method are performed (e.g., fully or partially) by one or more of the computational components, for example, those shown in FIGS. 4 and 5.

Method 500 of evaluating agent performance in interactions and generating training recommendations for agents based on the evaluated agent performance may be executed by a processor of computing device 302, such as processor 303. For example, method 500 may allow rating agent performance in interactions and providing suggestions for improvement. An interaction may be an interaction or a recording of an interaction via a digital channel, e.g. a text-based chat such as an online chat or a text chat using an application between an agent device of an agent and a customer device of a customer. An interaction recording can be a textual representation of an interaction such as an audio transcription, a chat transcription an email or a transcript of any other form of digital communication.

In operation 502, a plurality of evaluation prompts for evaluating interaction data items of one or more interactions may be created. An interaction, e.g. an interaction recording such as a transcript of a conversation between an agent and a customer may include interaction data items. Interaction data items can be excerpts or snippets of an interaction recording, e.g. input from an agent or input from a customer in an interaction. For example, interaction data items can also be excerpts or snippets of interaction metadata and analytics results. Evaluation prompts may be commands that can be executed by an application, e.g. auto-evaluation and coaching opportunity finger engine 730. Evaluation prompts may be based on questions of evaluation protocols for agents of contact centers, e.g. they may include one or more questions of an evaluation form. Evaluation prompts may include, for example, questions that are used in the evaluation of an agent such as “What is the average handling time for a call for an agent?”.

In operation 504, evaluation results for the interaction data items using the plurality of evaluation prompts and machine learning may be generated. For example, a plurality of evaluation prompts may be used to assess whether an agent handled one or more interactions according to pre-set rules, e.g. a policy for handling agent customer interactions. Evaluation prompts may include questions for which answers or parameters can be identified within an interaction recording. For example, “Has a call been interrupted before a solution was provided to a customer. Evaluation prompts may include threshold parameters for interaction data items present in interactions and may allow comparing an interaction data item for an interaction, e.g. time for handling a customer agent interaction, with a threshold parameter for the interaction data items, e.g. average handling time of customer agent interactions among all agents of a contact center. Generated evaluation results may include answers to evaluation prompts that have been identified in an interaction. They may further include reasons for an evaluation result, may identify interaction data items that are above a threshold, e.g. meet or exceed expectations when compared to a threshold value for an interaction data item, may identify interaction data items that are below a threshold, e.g. don't meet expectations when compared to a threshold value for an interaction data item and can be summarized in a grade for an evaluation question within a certain scale, e.g. customer satisfaction for handling a call was rated 7 out of 10 (on a scale from 1 to 10, 10 being the highest and 1 being the lowest score).

In operation 506, training recommendation prompts for the evaluation results may be created. For example, training recommendation prompts may be created for evaluation results of an agent may be identified for evaluation results, that have not met a certain threshold for a specific interaction data item. E.g. in case that an agent's average handling time for interactions was evaluated as exceeding 10 minutes, a training recommendation prompt may be created that requests the provision of training recommendations that may enable an agent to improve on an average handling time for customer agent interactions.

In operation 508, training recommendations may be generated from training categories using the training recommendation prompts and machine learning. For example, created training recommendation prompts may be used to query training categories, e.g. a database of training categories. Training recommendations may be generated by retrieving training categories from a database that match the queried training categories of the training recommendation prompt. For example, in response to a training recommendation prompt that requests a training to improve the average handling time of an agent, training categories, e.g. stored in a database such as a vector store may be queried to generate training recommendations that include content that allows an agent to improve their average interaction handling time. For example, querying training categories via a recommendation prompt may allow generating training recommendations for an agent, that have been identified as improvable or that lie below a threshold, e.g. when compared to evaluation results of other agents or pre-set threshold values.

To effectively implement training recommendations, categories, assets, and instruments, collectively known as training materials may be used for an optimized coaching process. Training categories may include the following instructional components:
Focus Areas: By analyzing interaction data items, e.g. performance data and supplementary metrics, areas for agent improvement may be identified in evaluation results, e.g. they may be automatically identified by an application such as auto-evaluation and coaching opportunity finder engine 730. These areas, which are generalized at the organizational level, may also be referred to as “Concentration Zones.”

For example, an interaction data item such as AHT may be a key performance indicator (KPI) that measures the average amount of time an agent spends on handling a customer interaction, e.g. including talk time, hold time, and after-call work.

Behaviors of an agent during an interaction may be associated with specific behavioral traits, providing a more in-depth scope for agent-specific enhancement. For example, a behavioral trait may be “active listening”. Paying close attention to the customer's concerns and gathering information to address their needs quickly and accurately.

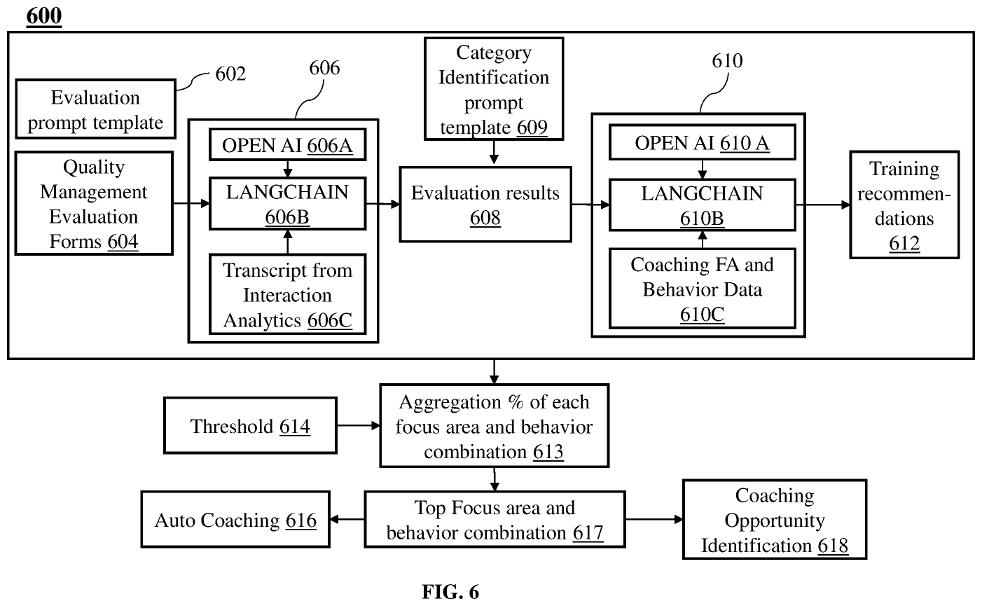

FIG. 6 is a high-level block diagram of an exemplary system 600 for periodic evaluation and identification of training opportunities.

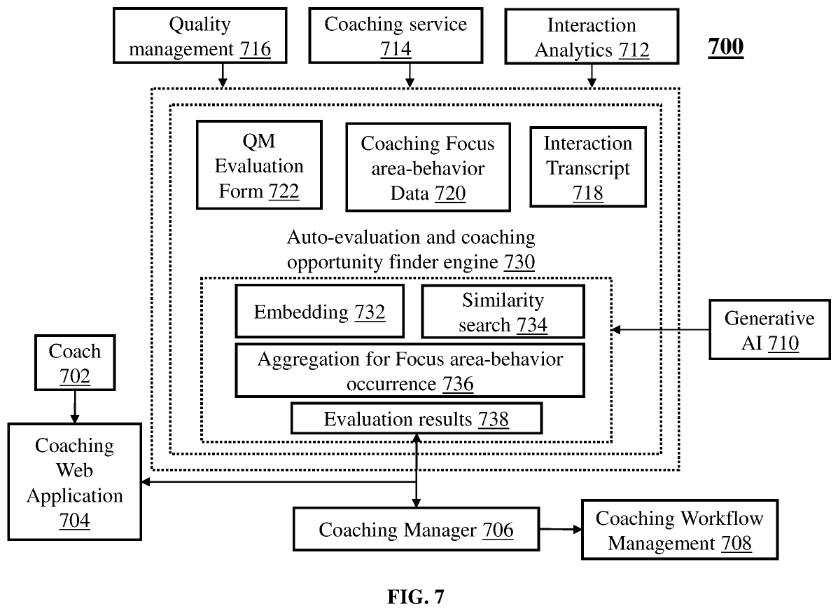

Evaluation prompts may be generated from evaluation prompt templates 602 and quality management evaluation forms 604 using machine learning. For example, Gen AI-based large language models (LLM) provided by Open AI 606A and LangChain 606B by LangChain Inc. as a framework to implement LLM in applications may be used to generate evaluation prompts from evaluation prompt templates 602 and transcripts from interaction analytics 606C which may include interaction data items. Input to a LLM may be in form of a prompt, e.g. an evaluation prompt or a training recommendation prompt or may include input that may be derived from an interaction recording. For example, evaluation questions and evaluation parameters of evaluation forms such as “Number of elevated calls to a supervisor for an agent” may be extracted from an evaluation form and used in the generation of an evaluation prompt. The extraction of content present in evaluation forms may be analyzed using Gen AI-based LLMs provided by OpenAI and LangChain as a framework to implement LLM in applications, e.g. in auto-evaluation and coaching opportunity finder engine 720. Other types of LLMs may be used. Interaction transcripts may be retrieved from an analytics engine, e.g. 822, and may be analyzed in the generation of evaluation results using the generated evaluation prompts (606). For example, questions of evaluation forms that have been embedded into evaluation prompts may be used in a similarity search to assess whether interaction items within an interaction transcript share or relate to the same content of as content included in an evaluation question. In a similarity search, a service may identify chunks of an interaction recording that are most relevant to an evaluation prompt created by a user by identifying a similarity of chunks, e.g. chunks that may include interaction data items, and a prompt, e.g. an evaluation prompt. This may be done by computing a similarity between a vector representation of a prompt and vectors of chunks, e.g. to identify a semantic similarity between chunks of an interaction recording and the evaluation prompt. Common similarity metrics include cosine similarity and Euclidean distance. Similar chunks may be selected as an answer to the prompt, e.g. an evaluation prompt. The generation of evaluation results is further described in FIGS. 7, 8 and 9.

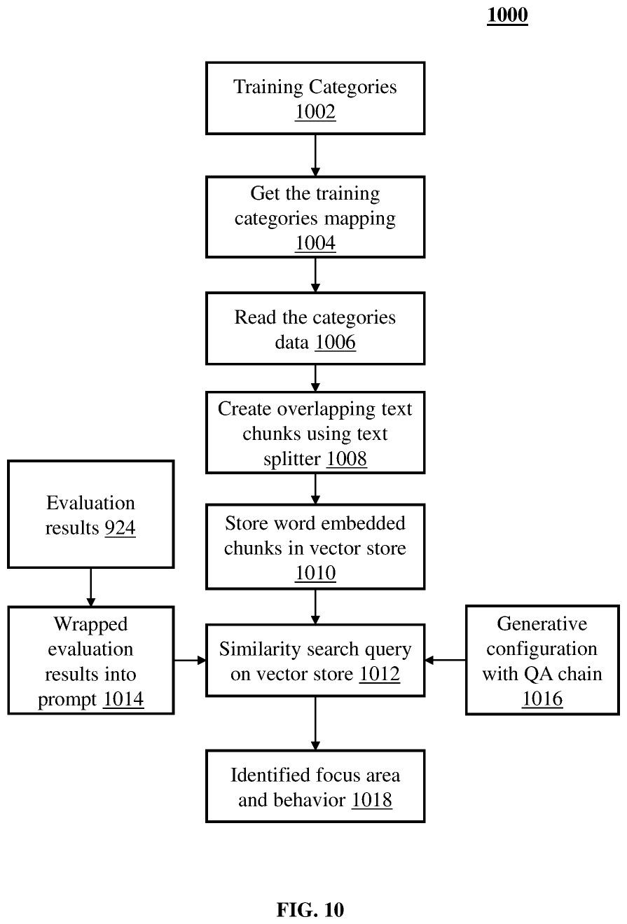

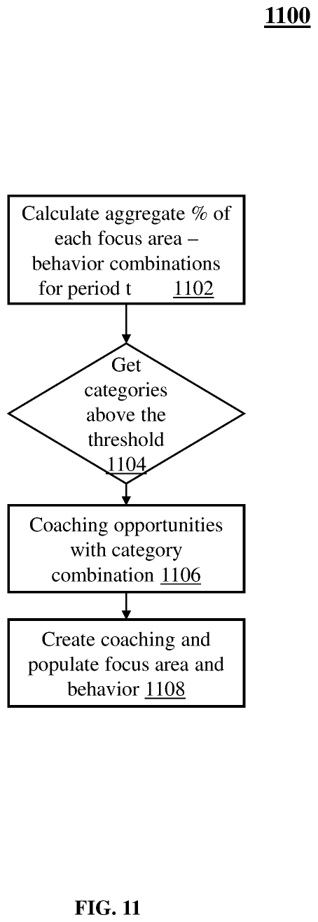

Evaluation results 608 may include one or more evaluation scores. The number of evaluation scores may depend on the number of created evaluation prompts that are used in the assessment of an interaction. For example, in case that three evaluation prompts are created, three interaction data items within an interaction may be evaluated and three evaluation scores may be obtained that can be compared, e.g. to pre-set threshold values for the performance indicators. Training recommendations 612 may be generated for evaluation results 608 by creating recommendation prompts from evaluation results using a category identification prompt template 609 and querying training categories using the created recommendation prompts. For example, evaluation results for which an agent may receive training opportunities may be embedded into training recommendation prompts. The extraction of content present in evaluation forms may be analyzed using machine learning, for example Gen AI-based LLMs provided by OpenAI and LangChain 610B as a framework to implement LLM in applications, e.g. in an auto-evaluation and coaching opportunity finder application 720. Training categories may be retrieved from an analytics engine, e.g. 822, and may be analyzed in the generation of evaluation results using the generated training recommendation prompts. In a similarity search, training categories may be mapped to content that is present in training recommendation prompts. In case that content in a training category is similar to content present in a training recommendation prompt, the relevant training opportunities that for the training recommendations may be assigned as a training recommendation for an agent (610). The generation of training recommendations is further described in FIGS. 10 and 11.

The identification of evaluation results may include the comparison of one or more performance indicators, identified in the interaction data items or determined by calculating the aggregation of each focus area and behavior combination 613, with pre-set threshold values 614 for the performance indicators. In the improvement of agent behavior in interaction with customers, agents may automatically be assigned auto-training (616) for identified performance indicators that lie below a pre-set threshold, e.g. also referred to as top focus areas and behavior combinations 617 or may select a training opportunity identification 618 with a supervisor, e.g. a coach 210, in person.

FIG. 7 shows a scheme of a high-level architecture 700 of an auto-evaluation and coaching opportunity finder engine.

A supervisor of an agent, e.g. coach 702, may utilize training applications to develop training sessions for agents. A coaching web application, e.g. coaching web service 704, may be used by a supervisor, e.g. coach 702, to create and manage coaching sessions.

Coaching web service 704 may automatically develop training sessions for an agent, e.g. by providing an agent with generated training recommendations. In one embodiment, a supervisor of an agent, e.g. a coach 704, may use a coaching web application 704 to provide an agent with a coaching session that includes training recommendations for an agent.

For example, a training session may be based on generated training recommendations and may include elements such as focus areas, behaviors and may select relevant participants, e.g. agents for a training session.

A coaching manager, e.g. coaching manager 706, may be a training service that is tasked with producing training sessions and may interact with other services to ensure the thorough completion of generating sessions by an agent. As mentioned earlier, this service may obtain training recommendations via a web application and may schedule a training session for an agent of a contact center within the system.

A training workflow management, e.g. training workflow management 708, may be used in the assignment of training recommendations (also referred herein as training opportunities) to agents, e.g. to notify an agent of a scheduled training, and to monitor the status of training opportunities provided to agents, e.g. whether or not an agent completed a scheduled training opportunity, e.g. training opportunity 818. For example, when an agent completes a training session, workflow management 708 may notify a coach that an agent, e.g. an agent using agent device 410, has completed an assigned training opportunity, for example by passing a training module or may indicate to a coach, e.g. coach 702, that an agent failed to complete a training session within a set time period, e.g. by marking the allocated training opportunity as “expired”. Training workflow management 708 may assist a training manager 706 in developing and overseeing workflows for every training session. These workflows may be practically executed utilizing any Workflow Service.

For example, a generative artificial intelligence (Gen AI) service 710 may be used to identify and/or retrieve interaction data items, e.g. an answer to a question of an interaction transcript, to evaluate an agent's performance for an interaction. A Gen AI services such as Open AI by Open AI Inc. has many models which can be used to identify interaction data items, e.g. Open AI GPT-3.5, Open AI GPT-3.5 turbo or Open AI GPT-4 may be used.

An interaction analytics software 712 may be an Enlighten service by Nice Ltd. which can provide interaction transcripts 718 of interactions, e.g. all interactions that an agent may have handled within a specific time period such as last week, last month or last year. A retrieved transcript may be analyzed using machine learning, e.g. Gen AI 710, to generate evaluation results and training recommendations.

A coaching service 714 may provide training categories, e.g. focus area and behavior data 720, and session-related information. Session-related information may include details on a training session, e.g. additional objectives for a training session and information on who can provide a training session, e.g. whether or not it is an automated online training session or an in person training session that is provided by a coach, e.g. coach 702. For example, session-related information may include attachments such as evaluations and interaction transcripts that may be used by a coach in a training session, or information for a training session in case that a coach delegated a training session to another coach. These categories may have focus areas and their associated behavior that can be used in the generation of training recommendations.

A Quality management of a contact center may have information related to evaluation forms.

A quality management service 716 may provide evaluation forms, e.g. QM evaluation forms 722, that may be used in the generation of evaluation prompts for evaluating interaction data items of one or more interactions. For example, an evaluation form may include questions that are related to the agent's behavior or responses to customer issues. Evaluation forms may be used to periodically evaluate agent's interaction with customers (e.g. every week, every months, every year).

An auto-evaluation and coaching opportunity finder engine 730 may create a plurality of evaluation prompts for evaluating interaction data items of one or more interactions and may generate evaluation results for the interaction data items using the plurality of evaluation prompts and machine learning. For example, engine 730 may periodically evaluate interactions of an agent, e.g. by accessing QM evaluation forms, and using machine learning, e.g. Gen AI to identify word embeddings 732, carry out a similarity search 734, e.g. using large language models such as LangChain by LangChain Inc.

In the generation of evaluation results 738, one or more performance indicators identified in the interaction data items may be compared with pre-set threshold values for the performance indicators, e.g. to create an aggregation for focus area-behavior occurrence 736. For the case that one or more performance indicators are lower than set thresholds for the one or more performance indicators, training recommendation prompts are created for the evaluation results, e.g. by mapping training recommendations, e.g. training opportunities to the coaching categories using training categories data. Coaching categories may be focus areas and behaviors. Focus areas can be parameters that can be derived from interaction data items, e.g. AHT. A coaching category may, thus include for example improving the AHT of an agent. Behaviors, e.g. active listening, effective questioning may be behavior characteristics of an agent that are linked to a focus area and improvement in the behavior characteristics of an agent during an interaction may improve a focus area. For example, to improve an AHT of an agent, an agent may receive a training that improves active listening and effective questioning of an agent.

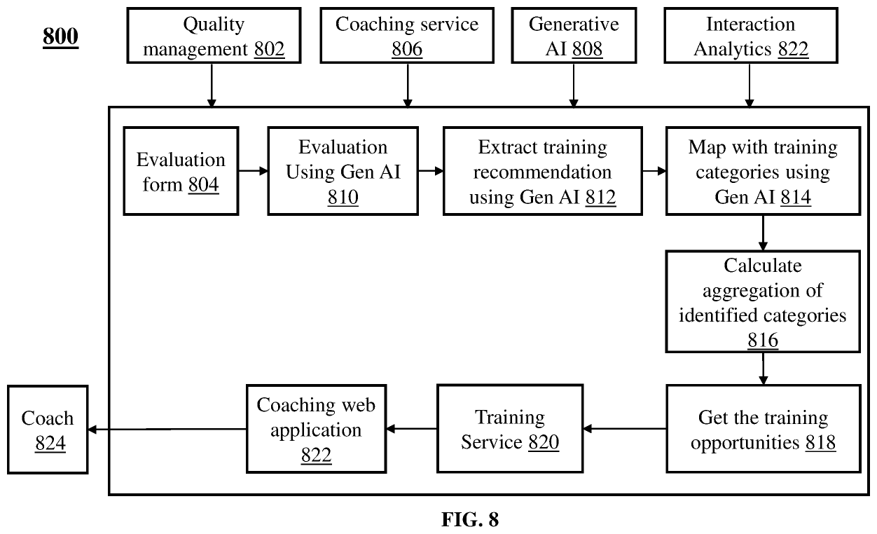

FIG. 8 is a high-level block diagram of an exemplary system 800 providing an overview of the data flow in a periodic evaluation and identification of training opportunities.

A quality management application 802 may represent a quality management service which has can provide evaluation forms, e.g. retrieve evaluation forms 804 from a data base such as storage 404. Evaluation forms may be created by supervisors of agents and may include questions related to agent's behavior and responses to customer questions.

In contact centers, quality management may be carried out to ensure that customer interactions adhere to a specified quality standard across all types of interaction channels and agents. For example, quality management may gain greater significance to guarantee that contact centers meet expectations of customers that interact with agents of contact centers.

A coaching service 806 may represent a coaching application/service which holds the information on coaching sessions, coaching content, participant responses, and categories. The solution eventually may require the use of training categories to map (814) identified training recommendations (812) to evaluation results to calculate an identified training categories 816 and generate training opportunities 818 for coaching session terms of a training service 820.

Generative AI 808 may be a subset of artificial intelligence that focuses on creating new content, designs, or patterns. A system may use generative AI models and large language models to generate evaluation results (810) from QM evaluation forms and interaction transcripts. A system may use generative AI models to identify training opportunities using training categories.

An interaction analytics service 822 may be a service that is responsible for providing and storing interaction transcripts and maintaining interaction data items of interactions.

An evaluation form 804 may be specific for a type of interaction. For example, evaluation form A may be an evaluation from that is suitable for the evaluation of an audio call between an agent and a customer whereas evaluation form B may be suitable for the evaluation of a chat transcript. Accordingly, evaluation forms may have specific tags associated with them that identifies, for example the type of interactions they can be used to evaluate. Based on an identified interaction a suitable evaluation form may be retrieved and used to automatically evaluate an agent interaction.

An evaluation using machine learning such as Gen AI in combination with a large language model and word embedding may allow evaluating an interaction. For example, each question of an evaluation form may be embedded into an evaluation prompt that is used to query an interaction transcript with the help of machine learning, e.g. Gen AI. A generated evaluation result may include items for a question such as, for example: an answer to a question, a reason for the answer, positive feedback, negative feedback, suggestions for improvements, and a grade for an assessed interaction date item.

In step 812, an application may extract training recommendations for evaluation results that include one or more performance indicators that are lower than set thresholds for the one or more performance indicators.

A step of mapping of coaching categories (step 814) may include training recommendations that have been generated in the previous steps to the training categories. The observed coaching recommendations may have to be mapped to training recommendations for specific interaction data items. Training recommendations may be wrapped into a training recommendation prompt and a similarity search query is applied to the training categories using Gen AI. The results of the similarity search may be training recommendations for an agent.

In the generation of training recommendations, aggregation of identified training categories may be calculated for evaluation results that were found to include one or more performance indicators that are lower than set thresholds for the one or more performance indicators.

Example formula 1 may represent the calculation of the number of aggregate training categories for a given duration t.

$$\frac{No . of occurence of category combination}{No . of low scoring evaluation} \cdot 100 \qquad Formula 1$$

For example, for a given duration t, e.g. one month, 100 calls of agent evaluation results may be generated from interaction data items present in one or more interactions. In one example, for 70 evaluations of interaction data items, it was found that the evaluation results that include one or more performance indicators were lower than a pre-set threshold value. The 70 evaluations may be separated according to the evaluated performance indicator, e.g. the number of occurrence of each category combination of the performance indicators, e.g.:
1. CSAT-Empathy=>44
2. Productivity-Actions=>17
3. CSAT-Communication=>9

Example formula 1 may be used to calculate an aggregate training category for each of the evaluated performance indicators:
1. CSAT-Empathy: ( 44/70)·100=62.86
2. Productivity-Actions: ( 17/70)·100=24.28
3. CSAT-Communication: ( 9/70)·100=12.86

Calculated values for aggregate training categories may be compared to a pre-set threshold. For example, in case that a category is below/above a pre-set threshold, an aggregate training category may be set as a training recommendation (also referred to as a coaching opportunity). For example, a value of 60 may be a threshold for aggregate training categories and CSAT-Empathy with a value of 62.86 may be a training recommendation (a coaching opportunity) for an agent.

In step 818, evaluation results may be received that have the highest aggregate percentage.

A coaching service 820 may communicate evaluation results to an agent and may schedule training sessions for an agent agents.

A coaching web application 822 may be used as an interface/application for managing a training, e.g. allows agents to review evaluation results and schedule training sessions for identified training opportunities.

A supervisor, e.g. coach 824 may use coaching web application 822 to create and manage training sessions for agents, e.g. a supervisor may send training invitations to agents.

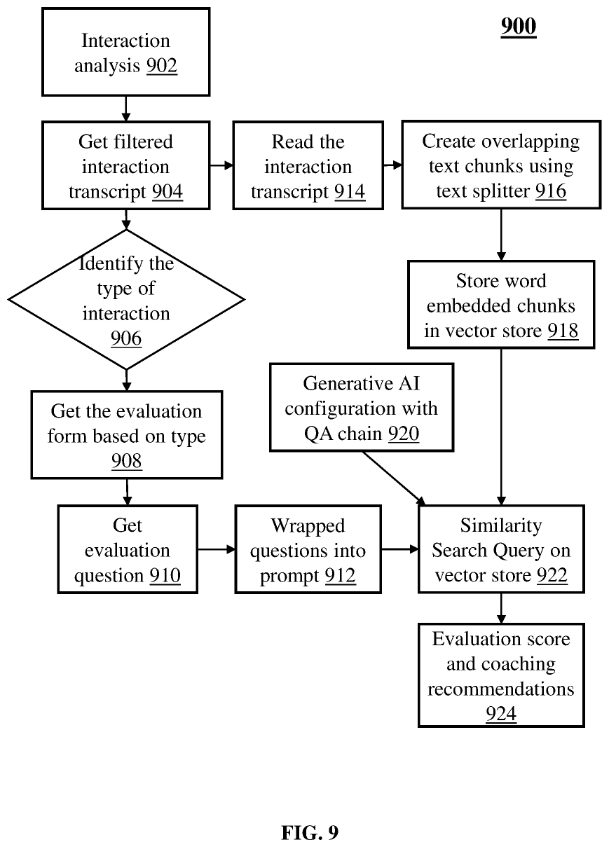

FIG. 9 represents steps for the auto-evaluation of interactions and getting coaching recommendations along with other attributes (900). The steps shown in FIG. 9 may be executed in a periodically, e.g. daily or weekly.

In step 902, interactions and their transcripts may be retrieved, e.g. using filtering criteria that are available to a quality management planner. A quality management planner is a service that can filter interactions by interaction data items that are present in an interaction. For example, interactions may be filtered using filters such as: media type of the interaction, channel type, categories with confidence value, behavioral parameters, skills and/or sentiments.

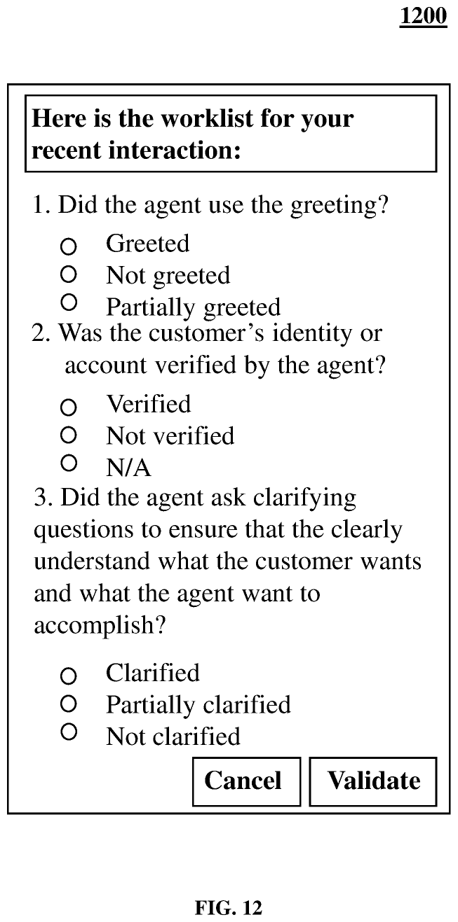

Once these interactions are filtered, the type of interaction present in the interaction transcript may be identified (step 904). Based on the type of identified interaction 906, e.g. a phone call, a web-chat or a video call, an evaluation form may be retrieved via an application, e.g. auto-evaluation and coaching opportunity finder engine 730, which may be used to evaluate the interaction (908). An example evaluation form may be shown in FIG. 12.

Each question from an evaluation form may be extracted or identified (step 910).

Using an evaluation prompt template each question that is used in the evaluation of an interaction may be wrapped in (e.g. have text or data added to) an evaluation prompt (step 912).

For example, an evaluation prompt template may read:

Answer the following question in a table with the following columns: Question ID: Answer: Reason, Coaching Topic, What went well, What can be improved, What could the agent say differently, Coaching Recommendation, Grade from 1-10 where 10 is the highest confidence Question {{Question}} {{description of options}}. Please do not include any confidential information in your answer. Hint: The answer to each question is in the transcript. You need to read it carefully. The answer is not based on your personal opinion, just based on what is in the transcript.

A transcript received from interaction analytics may be read programmatically using below code segment (914):

# location of the pdf file/files.
Reader = PdfReader(‘sample.pdf’)

In the creation of a plurality of evaluation prompts, evaluation prompts may include interaction data items which are present in previously or subsequently created evaluation prompts. For example, an interaction transcript may be broken into chunks that include interaction data items with some overlap between the chunks, e.g. overlap in textual content of the chunks, to maintain a continuity between interaction data items within previous and subsequent chunks of an interaction transcript as outlined in step 916:
Splitting large PDF files into smaller chunks with overlap when using Gen AI and a large language model may be used in the efficient processing, maintaining context, improving accuracy, and enabling parallel processing.
Artificial intelligence models can have a token limit, making it necessary to break down documents, e.g. interaction transcripts, to fit within this limit. Overlapping chunks preserve context and may ensure coherent answers.
Smaller sections can improve AI's understanding and accuracy, while parallel processing can speed up the overall evaluation of interactions.
Not-splitting and overlapping chunks can lead to incomplete processing, loss of context, reduced accuracy, and slower processing times. The AI process may miss information, e.g. essential interaction data items, and may provide less accurate evaluation results, and may take longer to analyze an interaction transcript in the generation of evaluation results.

For example, an example program code segment for text splitting may include:

```
# We need to split the text that we read into smaller chunks so that during
information retreival
text_splitter = CharacterTextSplitter(
  separator = “\n”,
  chunk_size = 1000,
  chunk_overlap = 200,
  length_function = len,
)
texts = text_splitter.split_text(raw_text)
```

In step 918, chunks may be indexed by performing word embedding of the chunks using LangChain OpenAI Embeddings and database, e.g. vector store, for each embedded chunk that may be created, for example, using FAISS (Facebook AI Similarity Search by Meta Platforms Inc.). A vector store may be a data storage structure, e.g. a database, that allows efficiently storing and managing of high-dimensional vectors such as performance indicators of interaction data items. Vectors (e.g., ordered lists of numbers) may be generated by converting textual or other complex data, e.g. present in interaction recordings or chunks of interaction recordings, into numerical representations using techniques like word embeddings, sentence embeddings, or other feature extraction methods. Vector stores can be optimized for fast and accurate similarity search, nearest neighbor search, and other operations on vector data. For example, a sentence “The cat chased the ball” can be represented as the vector [0.1, 0.2, 0.3, 0.4, 0.5]+ [0.2, 0.4, 0.6, 0.8, 1.0]=[0.3, 0.6, 0.9, 1.2, 1.5].

The purpose of using may include, for example:
Semantic representation: Embeddings convert text chunks into numerical representations, capturing their meaning for better AI understanding.
Efficient search & retrieval: FAISS vector store enables fast, accurate retrieval of relevant chunks based on queries.
Uses approximate nearest neighbor search for quick identification of similar embeddings.

An example programming code segment that may be used in creating an embedding and vector store may include:

# Download embeddings from OpenAI
embeddings = OpenAIEmbeddings( )
docsearch = FAISS.from_texts(texts, embeddings)

Various kinds of vector stores can be integrated with LangChain, such as Chroma, Faiss, Pinecone, etc. For example, Faiss can be used for vector store.

In step 920, the configuration of OpenAI and LangChain is done. This configuration may be achieved using, for example the programming code segment below:

chain = load_qa_chain(OpenAI(model_name=“gpt-4”, temperature=0.0,
engine = “gpt-4”), chain_type=“stuff”)

Executing step 922, a QA (Question-Answering) chain may be loaded using OpenAI's model GPT-4, and a custom chain_type “stuff”. The QA chain may be a series of AI models or functions that work together to provide answers to user queries. A QA chain may be a series of steps that may allow evaluating interaction transcripts based on questions, e.g. present in evaluation forms of agents, e.g. evaluation form 804. In some embodiments, OpenAI and LangChain may be used to perform QA on an interaction transcript; other models may be used. In the evaluation, an auto-evaluation and coaching opportunity finder engine 730 may be used to conduct the generation of chunks that include interaction data items from an interaction recording, vectorization, similarity search, and OpenAI's large language models to generate an evaluation result for interaction data items present that are present in an interaction.

The function “load_qa_chain( )” may initialize and load a QA chain with the specified AI model and chain_type.

The function “OpenAI (model_name=” gpt-4″, temperature=0.0, engine=“gpt-4”)” may create an instance of the OpenAI model (hypothetical GPT-4) with the specified parameters.

The variable “model_name” may be an AI model to be used, e.g. “gpt-4”.

The function “temperature” may allow controlling the randomness of the AI's output. A value of 0.0 may result in deterministic output (less random).

The variable “engine” may refer to a specific OpenAI API engine that may be used for processing, “gpt-4” in this case.

The function “chain_type=” stuff” may specifies a custom chain_type, e.g. “stuff”, which could be a custom configuration or set of functions used in the QA chain.

The variable “chain” allows storing the loaded QA chain in the variable chain.

Once the chain is loaded, it can be used to process queries and provide answers based on the AI model (GPT-4) and the specified chain_type “stuff”.

A question-wrapped prompt, generated in step 912 may be used to query the similarity search on vector search we have created in step 918 with the help of a chain created in step 920.

An example for a programming code segment used in a similarity search is shown below:

query = ″Did the representative use the proper greeting? give answer in
Yes or No only″
docs = docsearch.similarity_search(query)
chain.run(input_documents=docs, question=query)

The example programming code segment for a similarity search may demonstrate a process for finding an answer to a specific question from a set of documents using a document similarity search and a pre-loaded QA chain.

The variable “query” may store the question to be answered. For example, it may store the question: “Did the representative use the proper greeting? give answer in Yes or No only”.

The function “docsearch.similarity_search(query)” may perform a similarity search on the document embeddings (created earlier using OpenAI and FAISS) to find the most relevant documents based on the query. The result is a list of relevant documents (or chunks of text) that are most likely to contain the answer to the question.

The variable “docs” may store the list of relevant documents retrieved by the similarity search.

The function “chain.run(input_documents=docs, question=query)” may execute the QA chain on the relevant documents (docs) using the given question (query). A QA chain may process input documents and may extract an answer to the question, which will be in the format specified in the query (Yes or No, in this case).

In summary, this program code segment may demonstrate the process of finding relevant documents based on a query, and then using a pre-loaded QA chain to extract the answer to the query from those documents.

An example output of an evaluation result 924 for an evaluation prompt created for the evaluation of an interaction data item may include: an answer to the question present in the prompt, a reason for the answer, positive feedback, negative feedback, suggestions for improvements in dealing with the question and a grade how a question was handled.

Generated evaluation results may be used in the generation of training recommendations as shown in FIGS. 10 and 11.

FIG. 10 is a high-level block diagram of an exemplary method 1000 for the identification of training categories.

In step 1002, training categories, e.g. a training categories mapping 1004, may be received from a training service such as coaching service 806, training categories may be specific to the interaction for which an evaluation result and training recommendations are generated. For example, an interaction such as a phone call may include the assessment of interaction data items such as voice volume and/or speed of conversation whereas an interaction recording such as a chat transcript may include interaction data items such as correct spelling and/or interpunctuation. Training categories may include focus area and its associated behaviors with their definition.

In step 1006, an application may read categories data in similar way as shown in step 914.

In step 1008, a categories data file may be broken into different chunks with some overlap between the chunks, to maintain the continuity between the subsequent chunks. An example programming code segment and explanation of this step are mentioned in step 916.

In step 1010, chunks may be indexed before performing word embedding of the chunks using LangChain OpenAI Embeddings and vector store for each embedded chunk is created, for example, using FAISS for categories data. An example programming code segment and explanation of this step are mentioned in step 918.

In step 1012, evaluation results generated in step 924 may be wrapped in a training recommendation prompt template. An example for a training recommendation prompt template may read:

Given a coaching recommendation identify the focus area and the behavior relevant to the coaching recommendation provided. Select the focus Area after going through its definition of it and select the behavior which is associated with that focus area. If you find multiple behaviors matching, give them comma separated. If you are not sure of the Focus area and behavior and then output ‘N/A’. Following is the Coaching Recommendation: {{coaching recommendations}}

In step 1012, a configuration of OpenAI and LangChain may be performed, for example using programming code segment:

chain = load_qa_chain(OpenAI(model_name=“gpt-4”, temperature=0.0,
engine = “gpt-4”), chain_type=“stuff”)

An example programming code segment and explanation of this step is mentioned in step 920.

Evaluation results 924 may be wrapped into a training recommendation prompt generated in step 1014. Training recommendation prompt 1014 may be used to query the similarity search on vector search that was created in step 1012 with the help of chain created in step 1016.

An example programming code segment used in the similarity search may be:

query = ″Given coaching recommendations identify the focus area and
the behavior relevant to coaching recommendation provided.″
docs = docsearch.similarity_search(query)
print(chain.run(input_documents=docs, question=query))

In step 1018, results of the Identified focus area behavior combination may be shown in a screenshot. These result may be periodically stored in a database linked to a specific agent.

FIG. 11 is a high-level block diagram of an exemplary method 1100 for the creation of training recommendations from evaluation results.

In step 1102, an aggregate of a focus area behavior combination for a given period t may be calculated according to example formula 1.

A solution to the calculation may allow identifying the top categories which are above the configured threshold in step 1104.

In step 1106, training recommendations may be identified in terms of focus area behavior combination

In step 1108, generated output for training recommendations can be used to create a draft coaching for agents in auto coaching.

A supervisor may use an interface, e.g. coaching application 822, to review the coaching opportunities/training recommendations which have been identified for an agent. Using the interface, e.g. coaching application 822, they can directly create a coaching for an agent. Also, a periodic automated application, e.g. coaching application 822, can auto-populate the opportunities identified in step 1108 and may create draft training recommendations for an agent. This coaching can have the Focus area behavior auto-populated.

### Simulation and Test Results:

### Generation of Evaluation Results:

FIG. 12 shows a screenshot of an example for an evaluation form 1200 that represents an evaluation form of a Quality management.

An example for an evaluation prompt template that can be used to evaluate an interaction by embedding the question and their description may read:

Answer the following question in a table with the following columns: Question ID: Answer: Reason, Coaching Topic, What went well, What can be improved, What could the agent say differently, Coaching Recommendation, Grade from 1-10 where 10 is the highest confidence Question {{Question}} {{description of options}}. Please do not include any confidential information in your answer. Hint: The answer to each question is in the transcript. You need to read it carefully. The answer is not based on your personal opinion, just based on what is in the transcript.
An example for an execution prompt on vector search using open AI may read: query=“Answer the following question in a table with the following columns: Question ID: Answer: Reason, Coaching Topic, What went well, What can be improved, What could the agent say differently, Coaching Recommendation, Grade from 1-10 where 10 is the highest confidence Question ID=2: Was the Customers' identity or account verified by the Agent? Optional Answer values: Verified OR Improper verification OR Not Verified or N/A Reason: please explain in 1 sentence why you gave that response, and quote the verification. What is verification: Improper verification may include but is not limited to the Agent provided prompts, hints or multiple attempts or the Agent failing the member during verification when correct information was provided. N/A—Not required when a call is for general information and we are permitted to provide it or when it is apparent we cannot assist. Please do not include any confidential information in your answer. Hint: The answer to each question is in the transcript. You need to read it carefully. The answer is not based on your personal opinion, just based on what is in the transcript.”

docs = docsearch.similarity_search(query)
print(chain.run(input_documents=docs, question=query)

Training categories, e.g. data focus area behaviors, mapping and description, may be retrieved using a training application and may be kept, e.g. in a PDF file. A snippet of such file may include focus areas such as, for example:

### AHT:

AHT is a key performance indicator (KPI) that measures the average amount of time an agent spends handling a customer interaction, including talk time, hold time, and after-call work. It is an important metric for contact centers because it can directly impact customer satisfaction.

### Behaviors:

Active listening: Paying close attention to the customer's concerns and gathering information to address their needs quickly and accurately.
Effective questioning: Asking relevant and targeted questions to collect necessary information from customers, which helps in understanding their issues and finding solutions efficiently.
Clear and concise communication: using simple, straight forward language to explain solutions or provide instructions, which can help reduce the time spent on each interaction.

An example for an evaluation prompt template may read:

Given a coaching recommendation identify the focus area and the behavior relevant to the coaching recommendation provided. Select the focus Area after going through its definition of it and select the behavior which is associated with that focus area. If you find multiple behaviors matching, give them comma separated. If you are not sure of the Focus area and behavior and then output ‘N/A’. Following is the Coaching Recommendation: {{coaching recommendations}}

An example for an output of evaluation results for an agent may read:
Focus area: Customer Satisfaction
Behaviors: Empathy, Effective communication
   An output for an agent may be stored in a database.

For a given time duration t, aggregation of each focus area behaviors combination may be calculated for an agent using example formula 1.

$$\frac{No . of occurence of category combination}{No . of low scoring evaluation} \cdot 100 \qquad Formula 1$$

Table 1 is an example summary of evaluation results for an agent 1. The evaluation results shown in Table 1 may include focus areas, e.g. CSAT and Productivity and analyzed behaviors of interactions for the focus areas.

TABLE 1
Summary of example evaluation results for an agent 1

| | | | Total Low | Combi- | Aggre- |
|---|---|---|---|---|---|
| Agent | | | Scoring | nation | gation |
| ID | Focus area | Behavior | Interaction | Count | score |
| 1 | CSAT | Empathy | 125 | 77 | 61.6 |
| | Productivity | Actions | 125 | 32 | 26.6 |
| | CSAT | Communication | 125 | 13 | 10.4 |
| | Productivity | Questioning | 125 | 2 | 1.6 |
| | CSAT | Ownership | 125 | 1 | 0.8 |

Deficiencies in competences of agents in handling interactions with customers may be identified by comparing one or more performance indicators of the evaluation results with pre-set threshold values for the performance indicators.

TABLE 2
Example identification of deficiencies in evaluation
results for an agent 1.

| | | Aggregation |
|---|---|---|
| Focus Area | Behavior | Score |
| CSAT | Empathy | 61.6 |
| Productivity | Actions | 26.6 |
| CSAT | Communication | 10.4 |
| Productivity | Questioning | 1.6 |
| CSAT | Ownership | 0.8 |

Evaluation results may be used by an auto-evaluation and coaching opportunity finder engine 730 in the generation of training recommendations for an agent.

Sample Prompt 1 may be used for an auto-evaluation of an interaction using embedded questions of an evaluation form. Embedded questions for which an evaluation result is desired follow after the term “Question:”:

Answer the following question in a table with the following columns: Question ID: Answer: Reason, Coaching Topic, What went well, What can be improved, What could the agent say differently, Coaching Recommendation, Grade from 1-10 where 10 is the highest confidence Question: Did the Agent provide a positive Customer experience? Optional Answer values: Positive experience or Neutral experience or Negative experience Reason: please explain in 1 sentence why you gave that response What you can base the experience definition on: Positive experience is defined not by whether or not the caller was pleased with the result but rather the Agent's ability to connect with the Customer and demonstrate that the Customer's call or request is important to the company. For example, this can be demonstrated by these kinds of questions asked by the Agent during the call: Did the Agent display an interest in why the Customer called? If life events were mentioned during the call did the Agent acknowledge this? When an inconvenience was identified, did the Agent respond with an acknowledgment statement or empathy as appropriate? Did the Agent demonstrate active listening? Did the Agent sound like the member's call/issue was important to the company? Would the company be pleased with how we took care of their Customer? If we are unable to assist at the time of the Customer's call did the Agent relay what could be done in the most positive manner? Please do not include any confidential information in your answer. Hint: The answer to each question is in the transcript. You need to read it carefully. The answer is not based on your personal opinion, just based on what is in the transcript.

Output 1 from generative AI for Sample Prompt 1:
Question ID: 5
Answer: neutral experience.
Reason: The agent addressed the issue and provided information about the outage, but did not display much interest in the Customer's situation or acknowledge any inconvenience caused.
Coaching topic: Demonstrating empathy and active listening.
What went well: The agent provided information about the outage and promised to resolve the issue by the end of the chat.
What can be improved: The agent could have acknowledged the inconvenience caused by the outage and displayed more interest in the Customer's situation.
What could the agent say differently: The agent could have said something like “I'm sorry to hear that the outage is affecting your ability to work from home. I understand how frustrating that can be and I'll do my best to resolve the issue for you as quickly as possible.”
Coaching recommendation: provide training on active listening and demonstrating empathy.
Grade: 6

Sample Prompt 2 may be used for an auto-evaluation of an interaction using embedded questions of an evaluation form. Embedded questions for which an evaluation result is desired follow after the term “Question:”:
Answer the following question in a table with the following columns: Question ID: Answer: Reason, Coaching Topic, What went well, What can be improved, What could the agent say differently, Coaching Recommendation, Grade from 1-10 where 10 is the highest confidence Question: Was the Customers' identity or account verified by the Agent? Optional Answer values: Verified OR Improper verification OR Not Verified or N/A Reason: please explain in 1 sentence why you gave that response, and quote the verification. What is verification: Improper verification may include but is not limited to the Agent provided prompts, hints or multiple attempts or the Agent failing the member during verification when correct information was provided. N/A—Not required when a call is for general information and we are permitted to provide it or when it is apparent we cannot assist. Please do not include any confidential information in your answer. Hint: The answer to each question is in the transcript. You need to read it carefully. The answer is not based on your personal opinion, just based on what is in the transcript.

Output 2 from generative AI for Sample Prompt 2:
Question ID: 2
Answer: verified.
Reason: The customer provided their account number, name, and date of birth, which the agent used to verify their identity. “Sure, my account number is 123456789. My name is John Smith, and my date of birth is Jan. 10, 1985.”
Coaching topic: N/A.
What went well: The agent asked for the necessary information to verify the customer's identity and checked the account details.
What can be improved: N/A
What could the agent say differently: N/A
Coaching Recommendation: N/A
Grade: 10

### Generation of Training Recommendations:

Sample Prompt 1 may be an example prompt for a training recommendation prompt that may generate training recommendation prompts from evaluation results such as focus areas and behaviors:

Given a coaching recommendation identify the focus area and the behavior relevant to the coaching recommendation provided. Select the focus area after going through the definition of it and select the behavior which is associated with that focus area. If you find multiple behaviors matching, give them comma separated. If you are not sure of the Focus area and behavior and then ‘Not Sure’. Following is the Coaching Recommendation: Provide training on active listening and demonstrating empathy.

Generated Output 1 via machine learning using generative AI may be an example of a training recommendation generated from training recommendation prompt “Sample Prompt 1”:
Focus area: Customer Satisfaction
Behaviors: Active listening, Empathy

Sample Prompt 2 may be an example for a training recommendation prompt that may generate training recommendation prompts from evaluation results such as focus areas and behaviors:

Given an evaluation result identify the focus area and the behavior relevant to the coaching recommendation provided. Select the focus area after going through its definition of it and select the behavior which is associated with that focus area. If you find multiple behaviors matching, give them comma separated. If you are not sure of the Focus area and behavior and then ‘Not Sure’. Following is the Coaching Recommendation: Continue providing empathetic and efficient support to customers.

Generated Output 2 via machine learning using generative AI may be an example for training recommendations generated from training recommendation prompt “Sample Prompt 2”:
Focus area: Customer Satisfaction
Behaviors: Empathy, Effective communication

The evaluation results, together with for example the Answer, Reason, What went well, What can be improved, What could the agent say differently, Coaching Recommendation and Grade may then be used to pinpoint training categories by employing coaching categories data and generative AI. Over a specific period, category aggregations that cross the threshold are accurately identified using mathematical models.

Embodiments may improve the technology of employee evaluation, data handling and processing of interaction data, and production of training materials and prompts.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What claimed is:

1. A method of evaluating agent performance in interactions and generating training recommendations for agents based on the evaluated agent performance, the method comprising:
creating a plurality of evaluation prompts for evaluating interaction data items of one or more interactions;
generating evaluation results for the interaction data items using the plurality of evaluation prompts and machine learning;
creating training recommendation prompts for the evaluation results; and
generating training recommendations from training categories using the training recommendation prompts and machine learning.

2. A method according to claim 1, wherein generating evaluation results comprises comparing one or more performance indicators identified in the interaction data items with threshold values for the performance indicators.

3. A method according to claim 1, wherein the training recommendation prompts are created for the evaluation results that comprise one or more performance indicators that are lower than thresholds for the one or more performance indicators.

4. A method according to claim 1, wherein creating evaluation prompts comprises creating a vector store for the interaction data items.

5. A method according to claim 4, wherein generating evaluation results for the evaluation prompts comprises conducting a similarity search using the vector store.

6. A method according to claim 1, wherein the training categories are separated into training data items that are stored in a vector store.

7. A method according to claim 6, wherein generating training recommendations comprises conducting a similarity search using the training data items vector store.

8. A method according to claim 1, wherein the machine learning comprises generative artificial intelligence.

9. A method according to claim 8, wherein the evaluation prompts and training recommendation prompts are submitted to a large language machine learning model.

10. A method according to claim 1, wherein the training recommendations are based on previously generated evaluation results for the agent.

11. A method according to claim 1, wherein each evaluation prompt of the plurality of evaluation prompts comprises interaction data items which are present in previously or subsequently created evaluation prompts.

12. A system for evaluating agent performance in interactions and generating training recommendations for agents based on the evaluated agent performance, the system comprising:
a computing device;
a memory; and
a processor, the processor configured to:
create a plurality of evaluation prompts for evaluating interaction data items of one or more interactions;
generate evaluation results for the interaction data items using the plurality of evaluation prompts and machine learning;
create training recommendation prompts for the evaluation results; and
generate training recommendations from training categories using the training recommendation prompts and machine learning.

13. A system according to claim 12, wherein the generation of evaluation results comprises comparing one or more performance indicators identified in the interaction data items with pre-set threshold values for the performance indicators.

14. A system according to claim 12, wherein the training recommendation prompts are created for the evaluation results that comprise one or more performance indicators that are lower than the set thresholds for the one or more performance indicators.

15. A system according to claim 12, wherein the creation of evaluation prompts comprises creating a vector store for the interaction data items.

16. A system according to claim 15, wherein the generation of evaluation results for the evaluation prompts comprises conducting a similarity search using the created vector store.

17. A system according to claim 12, wherein the training categories are separated into training data items that are stored in a vector store.

18. A system according to claim 17, wherein the generation of training recommendations comprises conducting a similarity search using the created vector store.

19. A system according to claim 12, wherein the machine learning comprises generative artificial intelligence.

20. A method of rating agent performance in interactions and providing suggestions for improvement, the method comprising:
creating one or more prompts for the evaluation of interaction data items in one or more interactions;
generating performance results for the interaction data items using the one or more prompts for the evaluation of interaction data items and machine learning;
creating coaching recommendation prompts for the performance results; and
generating coaching recommendations from coaching categories using the coaching recommendation prompts and machine learning.
